(19) United States
(12) Patent Application Publication
(10) Pub. No.: US 2015/0116841 A1
(43) Pub. Date: Apr. 30, 2015

(54) ELECTRONIC DEVICE

(71) Applicant: Samsung Display Co., Ltd., Yongin-city (KR)

(72) Inventors: Byeong-Hwa CHOI, Seoul (KR); Seung-Bae LEE, Seoul (KR); Eun-Jung LEE, Seongnam-si (KR); Hak-Sun KIM, Seoul (KR)

(21) Appl. No.: 14/466,271

(22) Filed: Aug. 22, 2014

(30) Foreign Application Priority Data
Oct. 29, 2013 (KR) 10-2013-0129264

(51) Int. Cl. G02B 1/00

(52) U.S. Cl. CPC G02B 1/002
USPC 359/652

(57) ABSTRACT

An exemplary embodiment of the present inventive concept discloses an electronic device, including a display, a body to which the display is attached, wherein the body is coated with a meta-material, the meta-material configured to divert an electromagnetic wave based on refraction characteristics, and a display-cover that blocks the display from outside when the display is turned off, wherein the display-cover is coated with the meta-material.

### CROSS-REFERENCE TO RELATED APPLICATION

This application claims priority from and the benefit of Korean Patent Applications No. 10-2013-0129264, filed on Oct. 29, 2013, which is hereby incorporated by reference for all purposes as if fully set forth herein.

### BACKGROUND

1. Field

Exemplary embodiments of the present inventive concept relate generally to an electronic device. More particularly, exemplary embodiments of the present inventive concept relate to an electronic device including a display.

2. Discussion of the Background

Information may be transmitted in a form of electromagnetic waves. For example, radar may obtain location information of an object based on the electromagnetic radiation reflected from the object. Since human eyes obtain location information by sensing electromagnetic radiation within a visible spectrum, existence or location of an electronic device may be perceived by a human eye based on the sensed electromagnetic radiation within the visible spectrum. A meta-material is a material including periodic arrays of meta-atoms of metal or dielectric material, where a size of the meta-atom is much smaller than a wavelength of the electromagnetic waves. Since the meta-material may have a negative refractive-index or a very high refractive-index, propagation direction of the electromagnetic radiation may be controlled based on refraction characteristics resulting from the refractive-index of the meta-material. Recently, in order to satisfy the needs of customers, many manufacturers try to design an electronic device not to be easily seen when the electronic device is turned off. In this trend, for example, the electronic device including a display has been manufactured to have a narrow bezel, thereby having a small body. However, even if the electronic device including the display is manufactured to have the narrowest bezel, at least the display of the electronic device may be seen when the display does not perform a display function.

### SUMMARY

Exemplary embodiments of the present inventive concept provide an electronic device capable of diverting incident electromagnetic radiation when a display of the electronic device does not perform a display function.

Additional features of the invention will be set forth in the description which follows, and in part will be apparent from the description, or may be learned by practice of the invention.

An exemplary embodiment of the present inventive concept discloses an electronic device, including a display, a body to which the display is attached, wherein the body is coated with a meta-material, the meta-material configured to divert an electromagnetic wave based on refraction characteristics, and a display-cover configured to block the display from outside when the display is turned off, wherein the display-cover is coated with the meta-material.

An exemplary embodiment of the present inventive concept also discloses an electronic device including a flexible display, and a body coated with a meta-material, the meta-material configured to divert an electromagnetic wave based on refraction characteristics, wherein the flexible display is configured to be moved to an internal part of the body when the flexible display is turned off, and is configured to be moved to an external part of the body when the flexible display is turned on.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIGS. 1A and 1B are block diagrams illustrating an electronic device according to exemplary embodiments.

FIG. 2 is a diagram illustrating an exemplary embodiment in which incident electromagnetic radiation may be diverted by the electronic device of FIG. 1A.

FIG. 3A is a diagram illustrating an exemplary embodiment of the electronic device of FIG. 1A when a display is turned off.

FIG. 3B is a diagram illustrating an exemplary embodiment of the electronic device of FIG. 1B when a display performs a display function.

FIG. 4 is a diagram illustrating an exemplary embodiment in which a display-cover blocks a display from outside in the electronic device of FIGS. 1A and 1B.

FIG. 5 is a diagram illustrating another exemplary embodiment in which a display-cover blocks a display from outside in the electronic device of FIGS. 1A and 1B.

FIGS. 6A and 6B are block diagrams illustrating an electronic device according to exemplary embodiments.

FIG. 7 is a diagram illustrating an exemplary embodiment in which a flexible display is moved to an external part of a body in the electronic device of FIGS. 6A and 6B.

FIG. 8 is a diagram illustrating another exemplary embodiment in which a flexible display is moved to an external part of a body in the electronic device of FIGS. 6A and 6B.

FIG. 9 is a flow chart illustrating a method of operating an electronic device according to exemplary embodiments.

### DETAILED DESCRIPTION OF THE ILLUSTRATED EMBODIMENTS

Hereinafter, an electronic device according to the present inventive concept will be explained in detail with reference to the accompanying drawings. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

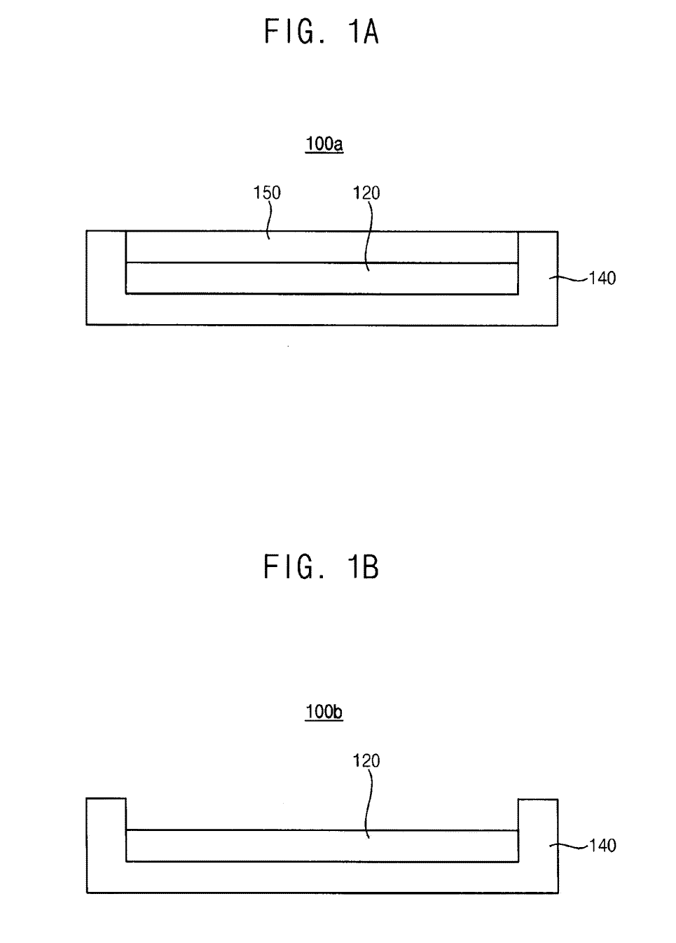

FIGS. 1A and 1B are block diagrams illustrating an electronic device according to exemplary embodiments.

Referring to FIGS. 1A and 1B, an electronic device 100A and 100B may include a display 120, a body 140, and a display-cover 150.

The display 120 may perform a display function. The display 120 may be exposed to outside of the electronic device 100B when the display 120 performs the display function. The display 120 may be attached to the body 140. In exemplary embodiments, the display 120 may be included in a touch-screen having a touch sensor.

The body 140 may be coated with a meta-material that diverts an electromagnetic radiation based on refraction characteristics. Alternatively, the body 140 may be manufactured with the meta-material. In exemplary embodiments, a touch-screen may be attached to the body 140. As described above, the touch-screen may include the display 120 (e.g. an organic light emitting display) and the touch sensor (e.g. capacitive or resistive touch sensor), and the body 140 may include a controller to control the display 120 and the touch sensor. In other words, the controller may control a display function and a touch sensing function of the touch-screen.

The body unit 140 may also include an application processor, a plurality of sensors, a memory device, a storage device, and a plurality of function devices. The application processor may perform various computing functions to control an overall operation of the electronic device 100A and 100B. For example, the application processor may be a micro-processor, a central processing unit (CPU), etc. The sensors may perform various sensing operations of the electronic device 100A and 100B. For example, the sensors may include, but not limited to, a gyro sensor that measures a rotating angular speed, an acceleration sensor that measures a speed and a momentum, a geomagnetic field sensor that acts as a compass, a barometer sensor that measures an altitude, a grip sensor that determines whether a mobile device is gripped by a user, a gesture-proximity-illumination sensor that performs various operations such as a motion recognition, a proximity detection, an illumination measurement, etc., and a temperature-humidity sensor that measures a temperature and a humidity. The memory device may store data for operations of the electronic device 100A and 100B. For example, the memory device may include a volatile semiconductor memory device such as a dynamic random access memory (DRAM) device, a static random access memory (SRAM) device, a mobile DRAM device, etc., and/or a non-volatile semiconductor memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. The storage device may include a solid state drive (SSD) device, a hard disk drive (HDD) device, a CD-ROM device, etc.

Additionally, the electronic device 100A and 100B may include function devices that may perform various operations of the electronic device 100A and 100B. For example, the function devices may include, but not limited to, a camera device that performs a camera function, a communication device that performs a communication function (e.g., code division multiple access (CDMA) module, long term evolution (LTE) module, radio frequency (RF) module, ultra wideband (UWB) module, wireless local area network (WLAN) module, worldwide interoperability for microwave access (WIMAX) module, etc.), a global positioning system (GPS) device, a microphone (MIC) device, a speaker device, etc.

The display-cover 150 may be coated with the meta-material to block the display 120 from the outside when the display 120 is turned off. Specifically, when the display 120 is turned off, the display 120 may be blocked from the outside by the body 140 and the display-cover 150. In other words, the display 120 may be surrounded with the meta-materials of the body 140 and the display-cover 150.

Referring to FIG. 1B, in some exemplary embodiments, the display-cover 150 may come out from an internal part of the body 140 to cover the display 120 when the display 120 is turned off.

When the display 120 is turned on, the display 120 may perform the display function. In some exemplary embodiments, the display-cover 150 may be moved to the internal part of the body 140 when the display function of the display 120 starts.

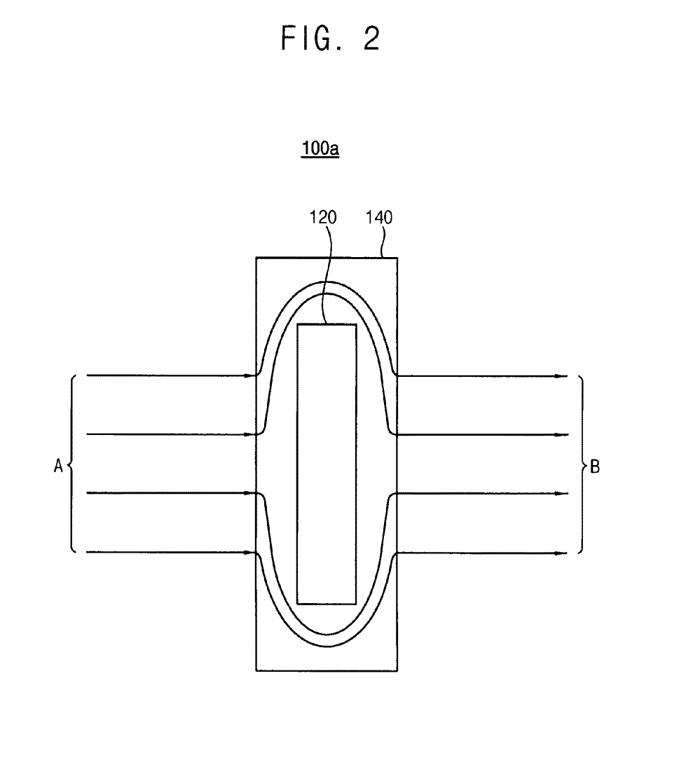

FIG. 2 is a diagram illustrating an exemplary embodiment in which incident electromagnetic radiation may be diverted by the electronic device of FIG. 1A.

Referring to FIG. 2, when the display 120 is turned off, the display 120 may be surrounded with the meta-materials of a body 140 and a display-cover 150 that are coated with the meta-material.

The meta-material may include periodic arrays of meta-atoms of metal or a dielectric material with a size of the meta-atom is much smaller than a wavelength of the electromagnetic waves. Since the meta-material may have a negative refractive-index or a very high refractive-index, propagation direction of the electromagnetic radiation may be controlled based on refraction characteristics resulting from the refractive-index of the meta-material. Furthermore, when the body 140 and the display-cover 150 are coated with a smart meta-material capable of changing an optical property of the meta-material based on a mechanical elastic strain, the body 140 and the display-cover 150 may control the propagation direction of the electromagnetic radiation (e.g. a light) based on the smart meta-material. The smart meta-material may also have elasticity. The smart meta-material having the elasticity that controls the propagation direction of the electromagnetic radiation is described in a paper ‘Broadband electromagnetic cloaking with smart meta-materials’ in Nature Communications 3, Article number: 1213, Published 20 Nov. 2012.

In other words, an incident electromagnetic radiation A toward the body 140 may be diverted by the meta-materials of the body 140, thereby passing through the body 140 as a refracted electromagnetic radiation B. In other words, progressions of the incident electromagnetic radiation may not be blocked by the display 120. For this reason, when the incident electromagnetic radiation is within a visible spectrum, the human eye may not be able to perceive the existence or location of the display 120 as well as the electronic device 100A based on the electromagnetic radiation.

According to the present exemplary embodiment, the display 120 may be surrounded with the meta-material for the progressions of the incident electromagnetic radiation not to be blocked by the display 120 when the display 120 is turned off in the electronic device 100A. For this reason, when the incident electromagnetic radiation is within the visible spectrum, the human eye may not perceive the existence or the location of the display 120 as well as the electronic device 100A. Although it is illustrated in FIG. 2 that the incident electromagnetic radiation has a direction toward one side of the electronic device 100A, a direction of the incident electromagnetic radiation is not limited thereto.

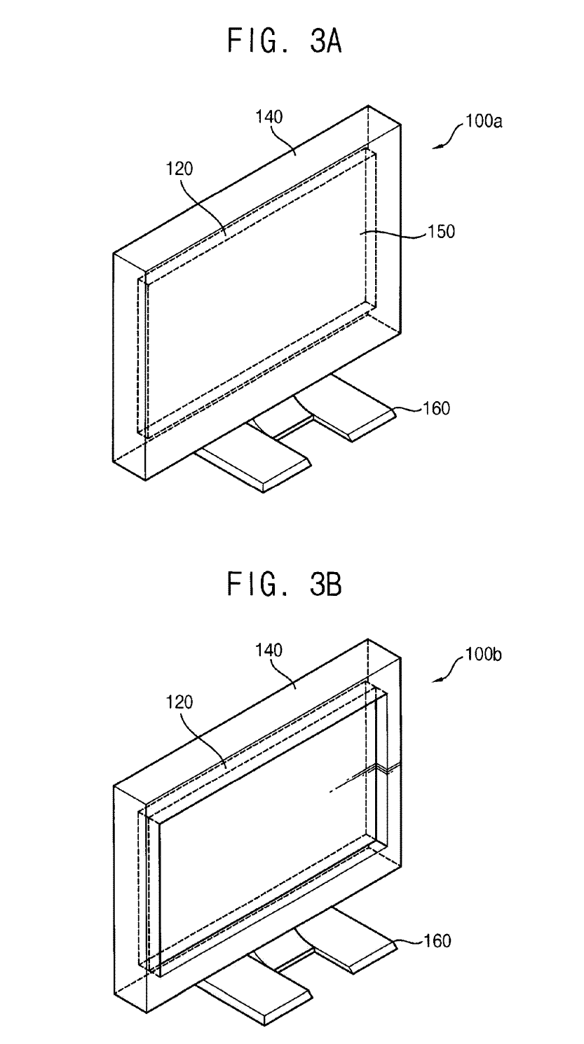

FIG. 3A is a diagram illustrating an exemplary embodiment of the electronic device of FIG. 1A when a display is turned off.

Referring to FIG. 3A, the electronic device 100A may include a display 120 and a body 140. Here, the display 120 may perform a display function. The electronic device 100A may further include a support stand 160.

When the display 120 is turned off, the display 120 may be surrounded with the body 140 and the display-cover 150 to block the display 120 from outside. In other words, the display 120 may be surrounded with meta-materials of the body 140 and the display-cover 150.

Since the meta-material may have a negative refractive-index or a very high refractive-index, propagation direction of the electromagnetic radiation may be controlled based on refraction characteristics resulting from the refractive-index of the meta-material.

As a result, incident electromagnetic radiation may be diverted by using the meta-material for progressions of the incident electromagnetic radiation not to be blocked by the display 120. Because of this, when the incident electromagnetic radiation is within a visible spectrum, the human eye may not be able to perceive existence or location of the display 120 as well as the electronic device 100a based on the electromagnetic radiation.

The support stand may support the body 140. In some exemplary embodiments, the support stand 160 may be coated with the meta-material to divert the incident electromagnetic radiation based on the refraction characteristics.

FIG. 3B is a diagram illustrating an exemplary embodiment of the electronic device of FIG. 1B when a display performs a display function.

Referring to FIG. 3B, the electronic device 100B may include a display 120 and a body 140. Here, the display 120 may perform a display function. The electronic device 100A may further include a support stand 160.

When the display is turned on, a surface of the display 120 (e.g. a display screen) may be exposed to outside of the body 140 to perform the display function. In other words, the display 120 may not be surrounded with a meta-material of the body 140, when the display 120 performs the display function.

Since the meta-material may have a negative refractive-index or a very high refractive-index, propagation direction of the electromagnetic radiation may be controlled based on refraction characteristics resulting from the refractive-index of the meta-material. As a result, incident electromagnetic radiation may be diverted by using the meta-material. Because of this, when the incident electromagnetic radiation is within a visible spectrum, the human eye may not perceive existence or location of the body 140 based on the electromagnetic radiation.

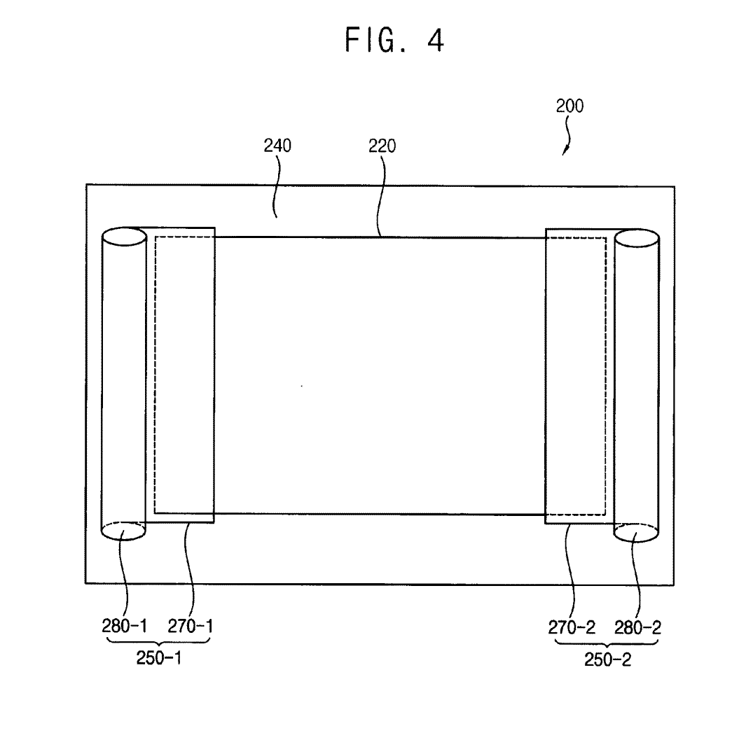

FIG. 4 is a diagram illustrating an exemplary embodiment in which a display-cover blocks a display from outside in the electronic device of FIGS. 1A and 1B.

Referring to FIG. 4, an electronic device 200 may include a display 220, a body 240, and a display-cover 250-1 and 250-2. Here, the display 220 may perform a display function. The display-cover 250-1 and 250-2 may be a film 270-1 and 270-2 that is coated with a meta-material. In exemplary embodiments, the film 270-1 and 270-2 may be moved by at least one cylindrical rotor 280-1 and 280-2 located in the internal part of the body 240. However, since constitutions and operations of the display 220 and the body 240 are substantially the same as constitutions and operations of the display and the body described referring to FIGS. 1A, 1B, 2, 3A, and 3B, the duplicated description will not be repeated.

The display-cover 250-1 and 250-2 may be the film 270-1 and 270-2 coated with the meta-material. The film 270-1 and 270-2 may block the display 220 from outside when the display 220 is turned off. As a result, the display may be surrounded with the meta-material, thereby diverting incident electromagnetic radiation. For this reason, when the incident electromagnetic radiation is within a visible spectrum, the human eye may not perceive existence or location of the display 220 as well as the electronic device 200 based on the electromagnetic radiation.

The cylindrical rotor 280-1 and 280-2 may move the film 270-1 and 270-2 based on a rotation of the cylindrical rotor 280-1 and 280-2. When the display 220 is turned on, the cylindrical rotor 280-1 and 280-2 may rotate and move the film 270-1 and 270-2 to an internal part of the body 240. When the display 220 is turned off, the cylindrical rotor 280-1 and 280-2 may rotate and move the film 270-1 and 270-2 to cover the display 220. In exemplary embodiments, the cylindrical rotor 280-1 and 280-2 may be a scroll that winds the film 270-1 and 270-2.

In exemplary embodiments, the cylindrical rotor 280-1 and 280-2 may be located in at least one of a left internal part of the body 240 and a right internal part of the body 240. The cylindrical rotor 280-1 and 280-2 may move the film 270-1 and 270-2 in a left and right direction of the body 240 (i.e., referred to as a horizontal direction).

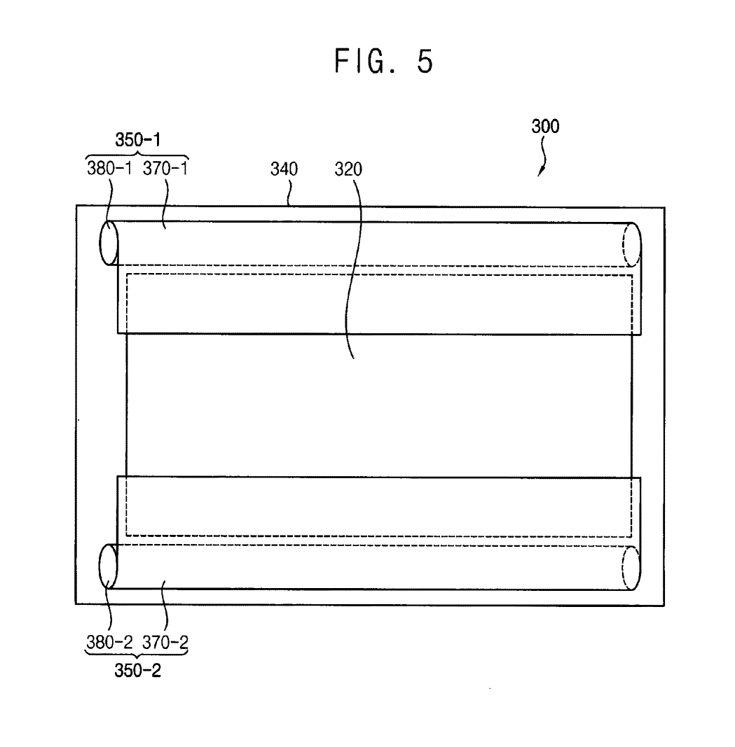

FIG. 5 is a diagram illustrating another exemplary embodiment in which a display-cover blocks a display from outside in the electronic device of FIGS. 1A and 1B.

Referring to FIG. 5, an electronic device 300 may include a display 320, a body 340, and a display-cover 350-1 and 350-2. Here, the display 320 may perform a display function. The display-cover 350-1 and 350-2 may be a film 370-1 and 370-2 that is coated with a meta-material. In exemplary embodiments, the film 370-1 and 370-2 may be moved by at least one cylindrical rotor 380-1 and 380-2 located in the internal part of the body 340. However, since constitutions and operations of the display 320 and the body 340 are substantially the same as constitutions and operations of the display and the body in FIGS. 1A, 1B, 2, 3A, and 3B, the duplicated description will not be repeated.

The display-cover 350-1 and 350-2 may be the film 370-1 and 370-2 that is coated with the meta-material, and the film 370-1 and 370-2 may block the display 320 from outside when the display 320 is turned off. As a result, the display may be surrounded with the meta-material, thereby diverting incident electromagnetic radiation. Because of this, when the incident electromagnetic radiation is within a visible spectrum, the human eye may not perceive existence or location of the display 320 as well as the electronic device 300 based on the electromagnetic radiation.

The cylindrical rotor 380-1 and 380-2 may move the film 370-1 and 370-2 by a rotation. When the display 320 is turned on, the cylindrical rotor 380-1 and 380-2 may rotate and move the film 370-1 and 370-2 to be moved to an internal part of the body 340. When the display 320 is turned off, the cylindrical rotor 380-1 and 380-2 may rotate and move the film 370-1 and 370-2 to cover the display 320. In exemplary embodiments, the cylindrical rotor 380-1 and 380-2 may be a scroll that winds the film 370-1 and 370-2.

In some exemplary embodiments, the cylindrical rotor 380-1 and 380-2 may be located in at least one of an upper internal part of the body 340 and a lower internal part of the body 340. The cylindrical rotor 380-1 and 380-2 may move the film 370-1 and 370-2 in an upper and lower direction of the body 340 (i.e., referred to as a vertical direction).

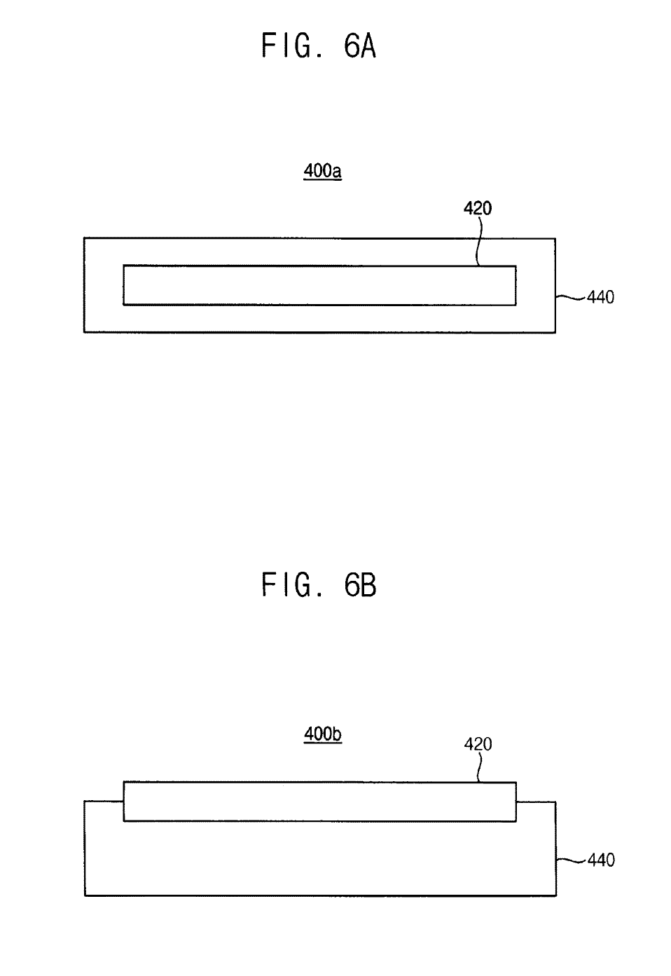

FIGS. 6A and 6B are block diagrams illustrating an electronic device according to exemplary embodiments.

Referring to FIGS. 6A and 6B, an electronic device 400A and 400B may include a flexible display 420 and a body 440. However, since constitutions and operations of the body 440 are substantially the same as constitutions and operations of the body described referring to FIGS. 1A and 1B, the duplicated description will not be repeated.

The flexible display 420 may be moved to an internal part of the body 440 when the flexible display 420 is turned off, and may be moved to an external part of the body 440 when the flexible display 420 is turned on. In some exemplary embodiments, the flexible display 420 may be included in a touch-screen having a touch sensor.

Referring to FIG. 6A, when the flexible display 420 is turned off, the flexible display 420 may be blocked from outside by the body 440. In other words, the flexible display 420 may be surrounded with a meta-material of the body 440. When the flexible display 420 is surrounded with the meta-material, incident electromagnetic radiation may be diverted by using the meta-material for progressions of the incident electromagnetic radiation not to be blocked by the flexible display 420. Because of this, when the incident electromagnetic radiation is within a visible spectrum, the human eye may not perceive existence or location of the flexible display 420 as well as the electronic device 400A based on the electromagnetic radiation.

Referring to FIG. 6B, when the flexible display is turned on, the flexible display 420 may be exposed to outside of the electronic device 400B. Then, the flexible display 420 may perform the display function.

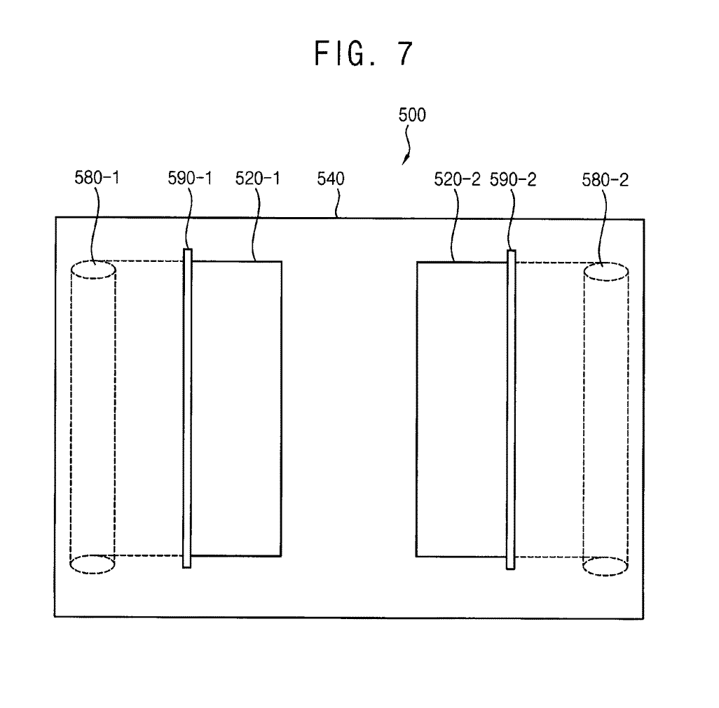

FIG. 7 is a diagram illustrating an exemplary embodiment in which a flexible display is moved to an external part of a body in the electronic device of FIGS. 6A and 6B.

Referring to FIG. 7, an electronic device 500 may include a flexible display 520-1 and 520-2, and a body 540. Here, the display 520-1 and 520-2 may perform a display function, and the body 540 may be coated with a meta-material. In some exemplary embodiments, the electronic device may further include a support stand that supports the body, and the support stand may be coated with the meta-material. However, since constitutions and operations of the body 540 are substantially the same as constitutions and operations of the body in FIGS. 1A to 1B, the duplicated description will not be repeated.

The flexible display 520-1 and 520-2 may be moved to an external part of the body 540 to perform the display function when the flexible display 520-1 and 520-2 is turned on. In some exemplary embodiments, the flexible display 520-1 and 520-2 may be moved by at least one cylindrical rotor 580-1 and 580-2 that is located in an internal part of the body 540. In some exemplary embodiments, the flexible display 520-1 and 520-2 may be moved to the external part of the body 540 through a slit 590-1 and 590-2 formed on the body 540. As a result, when the flexible display 520-1 and 520-2 is turned off, the flexible display 520-1 and 520-2 may be surrounded with the meta-material, thereby diverting incident electromagnetic waves. Because of this, when the incident electromagnetic radiation is within a visible spectrum, the human eye may not perceive existence or location of the flexible display 520-1 and 520-2 as well as the electronic device 500 based on the electromagnetic radiation.

The cylindrical rotor 580-1 and 580-2 may move the flexible display 520-1 and 520-2 by a rotation. When the flexible display 520-1 and 520-2 is turned on, the cylindrical rotor 580-1 and 580-2 may rotate and move the flexible display 520-1 and 520-2 to the external part of the body 540. When the flexible display 520-1 and 520-2 is turned off, the cylindrical rotor 580-1 and 580-2 may rotate and move the flexible display 520-1 and 520-2 to the internal part of the body 540. In exemplary embodiments, the cylindrical rotor 580-1 and 580-2 may be a scroll that winds the flexible display 520-1 and 520-2.

In some exemplary embodiments, the cylindrical rotor 580-1 and 580-2 may be located in at least one of a left internal part of the body 540 or a right internal part of the body 540. In some exemplary embodiments, the cylindrical rotor 580-1 and 580-2 may move the flexible display 520-1 and 520-2 in a left and right direction of the body 540 (i.e., referred to as a horizontal direction).

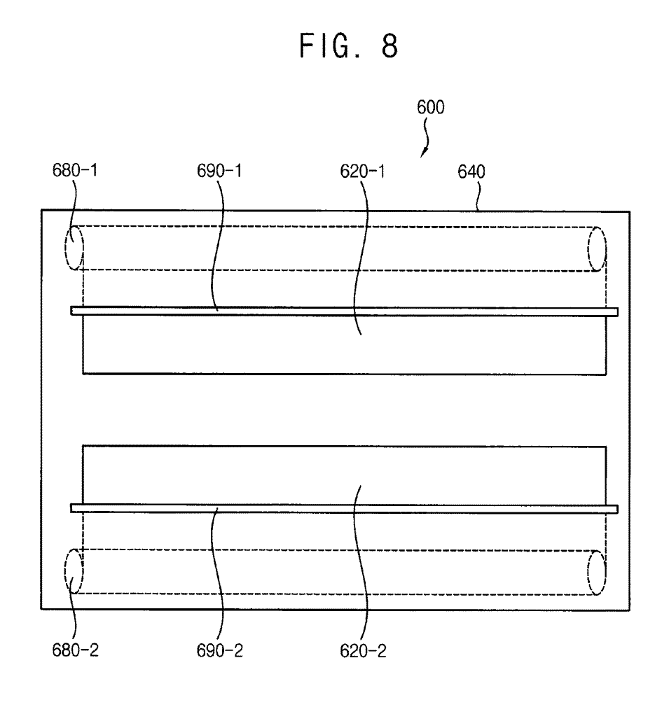

FIG. 8 is a diagram illustrating another exemplary embodiment in which a flexible display is moved to an external part of a body in the electronic device of FIGS. 6A and 6B.

Referring to FIG. 8, an electronic device 600 may include a flexible display 620-1 and 620-2, and a body 640. Here, the display 620-1 and 620-2 may perform a display function, and the body 640 may be coated with a meta-material. In exemplary embodiments, the electronic device may further include a support stand that supports the body, and the support stand may be coated with the meta-material. However, since constitutions and operations of the body 640 are substantially the same as constitutions and operations of the body in FIGS. 1A to 1B, the duplicated description will not be repeated.

The flexible display 620-1 and 620-2 may be moved to an external part of the body 640 to perform the display function when the flexible display 620-1 and 620-2 is turned on. In some exemplary embodiments, the flexible display 620-1 and 620-2 may be moved by at least one cylindrical rotor 680-1 and 680-2 located in an internal part of the body 640. In some exemplary embodiments, the flexible display 620-1 and 620-2 may be moved to the external part of the body 640 through a slit 690-1 and 690-2 formed on the body 640. As a result, when the flexible display 620-1 and 620-2 is turned off, the flexible display 620-1 and 620-2 may be surrounded with the meta-material, thereby diverting incident electromagnetic waves. Because of this, when the incident electromagnetic radiation is within a visible spectrum, the human eye may not perceive existence or location of the flexible display 620-1 and 620-2 as well as the electronic device 600 based on the electromagnetic radiation.

The cylindrical rotor 680-1 and 680-2 may move the flexible display 620-1 and 620-2 by a rotation. When the flexible display 620-1 and 620-2 is turned on, the cylindrical rotor 680-1 and 680-2 may rotate and move the flexible display 620-1 and 620-2 to the external part of the body 640. When the flexible display 620-1 and 620-2 is turned off, the cylindrical rotor 680-1 and 680-2 may rotate and move the flexible display 620-1 and 620-2 to the internal part of the body 640. In exemplary embodiments, the cylindrical rotor 680-1 and 680-2 may be a scroll that winds the flexible display 620-1 and 620-2.

In some exemplary embodiments, the cylindrical rotor 680-1 and 680-2 may be located in at least one of a left internal part of the body 640 or a right internal part of the body 640. In some exemplary embodiments, the cylindrical rotor 680-1 and 680-2 may move the flexible display 620-1 and 620-2 in an upper and lower direction of the body 640 (i.e., referred to as a vertical direction).

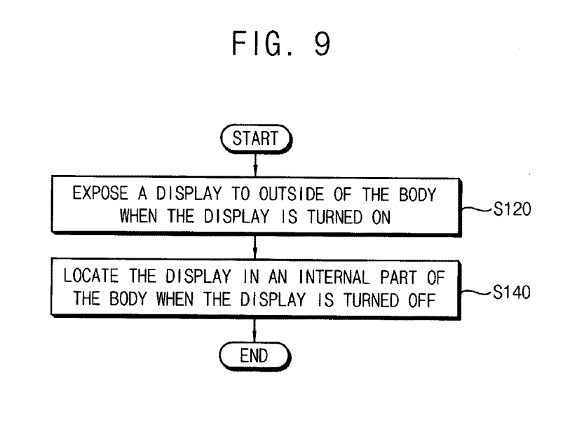

FIG. 9 is a flow chart illustrating a method of operating an electronic device according to exemplary embodiments.

Referring to FIG. 9, the method of FIG. 9 may operate an electronic device that includes a display and a body that is coated with a meta-material. Specifically, the method of FIG. 9 may expose the display to outside of the body when the display is turned on (S120), and then may locate the display in an internal part of the body when the display is turned off (S140).

When the display is exposed to outside of the body (S120), the display may perform a display function. When the display is located in the internal part of the body (S140), incident electromagnetic radiation may be diverted for progressions of the electromagnetic radiation not to be blocked by the display. Because of this, when the incident electromagnetic radiation is within a visible spectrum, the human eye may not perceive existence or location of the display as well as the electronic device based on the electromagnetic radiation.

In some exemplary embodiments, in order to expose the display to outside of the body (S120), a cylindrical rotor may move the display to the external part of the body.

In some exemplary embodiments, in order to locate the display in the internal part of the body (S140), a film being coated with the meta-material may block the display from outside. For example, a cylindrical rotor may move the film to block the display from outside.

The foregoing is illustrative of exemplary embodiments, and is not to be construed as limiting thereof. Although a few exemplary embodiments have been described, those skilled in the art will readily appreciate that many modifications are possible in the exemplary embodiments without materially departing from the novel teachings and advantages of exemplary embodiments. Accordingly, all such modifications are intended to be included within the scope of exemplary embodiments as defined in the claims. In the claims, means-plus-function clauses are intended to cover the structures described herein as performing the recited function and not only structural equivalents but also equivalent structures. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. The inventive concept is defined by the following claims, with equivalents of the claims to be included therein.

What is claimed is:

1. An electronic device, comprising:
a display;
a body to which the display is attached, wherein the body is coated with a meta-material, the meta-material configured to divert an electromagnetic wave based on refraction characteristics; and
a display-cover configured to block the display when the display is turned off, wherein the display-cover is coated with the meta-material.

2. The electronic device of claim 1, further comprising:
a support stand supporting the body, wherein the support stand is coated with the meta-material.

3. The electronic device of claim 1, wherein the display-cover is configured to be moved to an internal part of the body when the display is turned on.

4. The electronic device of claim 3, wherein the display-cover is a film coated with the meta-material.

5. The electronic device of claim 4, wherein the film is moved by at least one cylindrical rotor that is located in the internal part of the body.

6. The electronic device of claim 5, wherein the film is configured to be moved to the internal part of the body by the cylindrical rotor when the display is turned on, and
wherein the film is configured to be moved over the display by the cylindrical rotor to cover the display when the display is turned off

7. The electronic device of claim 6, wherein the cylindrical rotor is located in at least one of a left internal part of the body and a right internal part of the body.

8. The electronic device of claim 7, wherein the cylindrical rotor is configured to move the film in a left and right direction of the body.

9. The electronic device of claim 6, wherein the cylindrical rotor is located in at least one of an upper internal part of the body and a lower internal part of the body.

10. The electronic device of claim 9, wherein the cylindrical rotor is configured to move the film in an upper and lower direction of the body.

11. An electronic device, comprising:
a flexible display; and
a body coated with a meta-material, the meta-material configured to divert an electromagnetic wave based on refraction characteristics,
wherein the flexible display is configured to be moved to an internal part of the body when the flexible display is turned off, and is configured to be moved to an external part of the body when the flexible display is turned on.

12. The electronic device of claim 11, further comprising:
a support stand supporting the body, wherein the support stand is coated with the meta-material.

13. The electronic device of claim 11, wherein the flexible display is configured to be moved by at least one cylindrical rotor that is located in the internal part of the body.

14. The electronic device of claim 13, wherein the cylindrical rotor is configured to rotate and move the flexible display to the internal part of the body when the flexible display is turned off, and
the cylindrical rotor is configured to rotate and move the flexible display to the external part of the body when the flexible display is turned on.

15. The electronic device of claim 14, wherein the cylindrical rotor is located in at least one of a left internal part of the body and a right internal part of the body.

16. The electronic device of claim 15, wherein the cylindrical rotor is configured to move the flexible display in a left and right direction of the body.

17. The electronic device of claim 14, wherein the cylindrical rotor is located in at least one of an upper internal part of the body and a lower internal part of the body.

18. The electronic device of claim 17, wherein the cylindrical rotor is configured to move the flexible display in an upper and lower direction of the body.
